(19) United States
(12) Patent Application Publication
(10) Pub. No.: US 2012/0082119 A1
(43) Pub. Date: Apr. 5, 2012

(54) DATA TRANSMISSION/RECEPTION METHOD AND APPARATUS USING A TRANSMISSION DIVERSITY TECHNIQUE IN A WIRELESS COMMUNICATION SYSTEM

(75) Inventors: Jae Hoon Chung, Anyang-si (KR); Yeong Hyeon Kwon, Anyang-si (KR); Moon Il Lee, Anyang-si (KR); Hyun Soo Ko, Anyang-si (KR)

(73) Assignee: LG ELECTRONICS INC., Seoul (KR)

(21) Appl. No.: 13/319,295

(22) PCT Filed: May 10, 2010
(86) PCT No.: PCT/KR2010/002945

§ 371 Date: Dec. 2, 2011

Related U.S. Application Data
(60) Provisional application No. 61/176,496, filed on May 8, 2009.

(51) Int. Cl. H04W 72/04

(52) U.S. Cl. 370/329

(57) ABSTRACT

The present invention relates to a data transmission/reception method using a transmission diversity technique in a wireless communication system. In the data transmission/reception method using the transmission diversity technique in the wireless communication system according to one aspect of the present invention, a base station allocates a downlink resource to a terminal, precodes data for transmitting to the terminal, and allocates the precoded data and a non-precoded demodulation reference signal (DMRS) to the allocated resource in order to transmit same.

### TECHNICAL FIELD

The present invention relates to a wireless communication system and more particularly to a method and apparatus for transmitting and receiving data using a transmit diversity scheme in a wireless communication system.

### BACKGROUND ART

First, a frame structure of a wireless communication system is described below with reference to FIG. 1. FIG. 1 illustrates a frame structure of a Long Term Evolution (LTE) system. As shown in FIG. 1, one frame includes 10 subframes and one subframe includes 2 slots. A time required to transmit one subframe is referred to as a Transmission Time Interval (TTI). For example, one subframe may be 1 ms and one slot may be 0.5 ms.

One slot includes a plurality of Orthogonal Frequency Division Multiplexing (OFDM) symbols. An OFDM symbol may be referred to as an SC-FDMA symbol or symbol duration.

One slot includes 6 or 7 OFDM symbols depending on the length of a cyclic prefix (CP). In an LTE system, CPs are classified into a normal CP and an extended CP. One slot includes 7 OFDM symbols when a normal CP is used and includes 6 OFDM symbols when an extended CP is used.

As shown in FIG. 1, a primary synchronization channel (P-SCH) and a secondary synchronization channel (S-SCH) are transmitted to achieve synchronization every frame. A base station transmits a physical downlink control channel (PDCCH) in a 0th OFDM symbol and/or a 1st OFDM symbol of each subframe in order to transmit resource allocation information or the like of each subframe. Here, the base station may transmit the PDCCH in the 0th OFDM symbol or the 0th and 1st OFDM symbols depending on the size of the PDCCH.

FIG. 2 illustrates a resource structure of a downlink slot. Specifically, FIG. 2 shows an example in which one slot includes 7 OFDM symbols. One resource element (RE) is a resource region including one OFDM symbol and one subcarrier. One resource block (RB) is a resource region including a plurality of OFDM symbols and a plurality of subcarriers. For example, an RB may include 7 OFDM symbols in the time domain and 12 subcarriers in the frequency domain. The number of RBs included in one slot may be determined according to downlink bandwidth.

In a 3rd Generation Partnership Project (3GPP) Rel-8 system, a base station may transmit data using a transmit diversity scheme (T×D) as shown in Table 1 when the base station has 2 or 4 transmit antennas. Here, the transmit diversity scheme of Table 1 when the base station has 2 transmit antennas is referred to as a Space-Frequency Block Coding (SFBC) scheme and the transmit diversity scheme of Table 1 when the base station has 4 transmit antennas is referred to as a Space-Frequency Block Coding (SFBC)+Frequency Switching Transmit Diversity (FSTD) scheme.

TABLE 1

| | 2Tx | 4Tx |
|---|---|---|
| Transmission scheme for PDSCH (TxD) | $\frac{1}{\sqrt{2}} ( \begin{matrix}{S}_{1} & {S}_{2} \\ - {S}_{2}^{*} & {S}_{1}^{*}\end{matrix} )$ | $\frac{1}{\sqrt{2}} ( \begin{matrix}{S}_{1} & {S}_{2} & 0 & 0 \\ 0 & 0 & {S}_{3} & {S}_{4} \\ - {S}_{2}^{*} & {S}_{1}^{*} & 0 & 0 \\ 0 & 0 & - {S}_{4}^{*} & {S}_{3}^{*}\end{matrix} )$ |

Data transmitted through the transmit diversity scheme of Table 1 is demodulated using a Cell-specific Reference Signal (CRS). That is, a mobile station performs channel estimation using a CRS and demodulates the data using a resulting value of the channel estimation.

FIG. 3 illustrates a structure of a CRS according to the number of transmit antennas in a 3GPP LTE Rel-8 or Rel-9 system. The CRS structure of FIG. 3 is expressed on the basis of an RB in one subframe, where N RBs constitute one subframe. A CRS is defined in an overall system bandwidth in a cell specific manner.

A 3GPP LTE Rel-8 or Rel-9 mobile station measures a downlink channel using a CRS and feeds the measurement back to the base station and performs channel estimation for demodulating a PDCCH and a PDSCH using the CRS.

A frame of the 3GPP LTE-Advanced (LTE-A) system includes a normal subframe that may be used to transmit data to an LTE Rel-8 or Rel-9 mobile station and an LTE-A (Rel-10) mobile station and an LTE-A subframe that may be used to transmit only to an LTE-A mobile station.

However, a PDSCH region of an LTE-A subframe includes no CRS. Therefore, there is a problem in that an RS used for channel estimation, which is required for a mobile station to demodulate a PDSCH region, is not present in the case in which a base station transmits data to the mobile station using a transmission scheme (for example, an LTE Rel-8 or Rel-9 downlink multi-antenna transmit diversity scheme), which is defined such that channel estimation and demodulation are performed through a CRS, from among transmission schemes defined in the conventional LTE Rel-8 or Rel-9.

### DISCLOSURE

### Technical Problem

In the related art, there is a problem in that, if a base station transmits data to a mobile station using a transmit diversity scheme through an LTE-A subframe, an RS that is to be used by the mobile station to demodulate a PDSCH region is not present.

An object of the present invention is to provide a method for transmitting and receiving data using a transmit diversity scheme which allows a mobile station to demodulate a PDSCH region of data even when a base station has transmitted the data to the mobile station using a transmit diversity scheme through an LTE-A subframe.

Objects of the present invention are not limited to those described above and other objects will be clearly understood by those skilled in the art from the following description.

### Technical Solution

In order to achieve the objects of the present invention, in a method for transmitting data using a transmit diversity scheme in a base station in a wireless communication system in accordance with one aspect of the present invention, the base station allocates a downlink resource to a mobile station, precodes data to be transmitted to the mobile station, and arranges the precoded data and a non-precoded demodulation reference signal (DMRS) in the allocated resource and transmitting the precoded data and the non-pre coded DMRS.

In order to achieve the objects of the present invention, a method for receiving data using a transmit diversity scheme in a mobile station in a wireless communication system in accordance with another aspect of the present invention, the mobile station receives a downlink resource that has been allocated to the mobile station by a base station, receives precoded data and a non-precoded demodulation reference signal (DMRS) from the base station through the allocated resource, and demodulates the data using the DMRS.

Here, the DMRS may be transmitted for each antenna port used in the transmit diversity scheme.

The DMRS may include the same number of dedicated reference signal patterns as the number of the antenna ports.

Indices of the dedicated reference signal patterns may be consecutive.

In order to achieve the objects of the present invention, a base station in accordance with another aspect of the present invention may include a processor for precoding data to be transmitted to a mobile station and arranging the precoded data and a non-precoded demodulation reference signal (DMRS) in a resource region allocated to the mobile station, and transmitting the precoded data and the non-precoded DMRS using a transmit diversity scheme.

In order to achieve the objects of the present invention, a mobile station in accordance with another aspect of the present invention may include a reception module for receiving precoded data and a non-precoded demodulation reference signal (DMRS) through a resource region that has been allocated to the mobile station by a base station, and a processor for demodulating the data using the DMRS.

In order to achieve the objects of the present invention, in a method for transmitting semi-persistent scheduling (SPS) data using a transmit diversity scheme in a base station in a wireless communication system that supports an LTE mobile station and an LTE-A mobile station in accordance with another aspect of the present invention, the base station transmits frame configuration information indicating a position of an LTE-A subframe to a mobile station, transmits an SPS activation Physical Downlink Control Channel (PDCCH) including information associated with a transmission time of the SPS data to the mobile station, and transmits the SPS data to the mobile station at a next SPS data transmission time when the transmission time of the SPS data overlaps with the LTE-A subframe.

In order to achieve the objects of the present invention, in a method for receiving semi-persistent scheduling (SPS) data using a transmit diversity scheme in a mobile station in a wireless communication system that supports an LTE mobile station and an LTE-A mobile station in accordance with another aspect of the present invention, the mobile station receives frame configuration information indicating a position of an LTE-A subframe from a base station, receives an SPS activation Physical DL Control Channel (PDCCH) including information associated with a transmission time of the SPS data from the base station, and receives the SPS data from the base station at a next SPS data transmission time when the transmission time of the SPS data overlaps with the LTE-A subframe.

### Advantageous Effects

According to the embodiments of the present invention, a mobile station can demodulate data using a demodulation RS since a base station transmits the data using the transmit diversity scheme without precoding the demodulation RS.

Advantages of the present invention are not limited to those described above and other advantages will be clearly understood by those skilled in the art from the following description.

### DESCRIPTION OF DRAWINGS

FIG. 1 illustrates a frame structure of a Long Term Evolution (LTE) system.

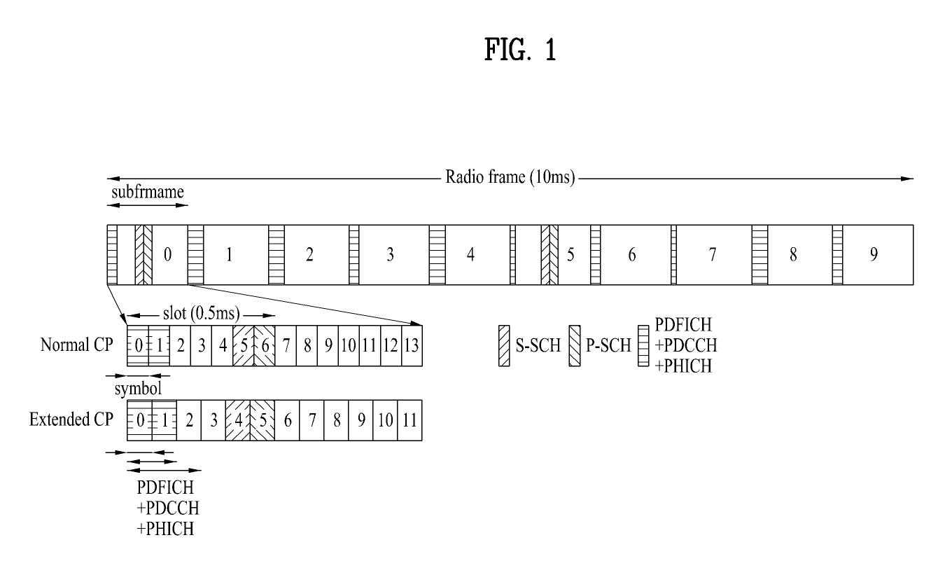

FIG. 2 illustrates a resource structure of a downlink slot.

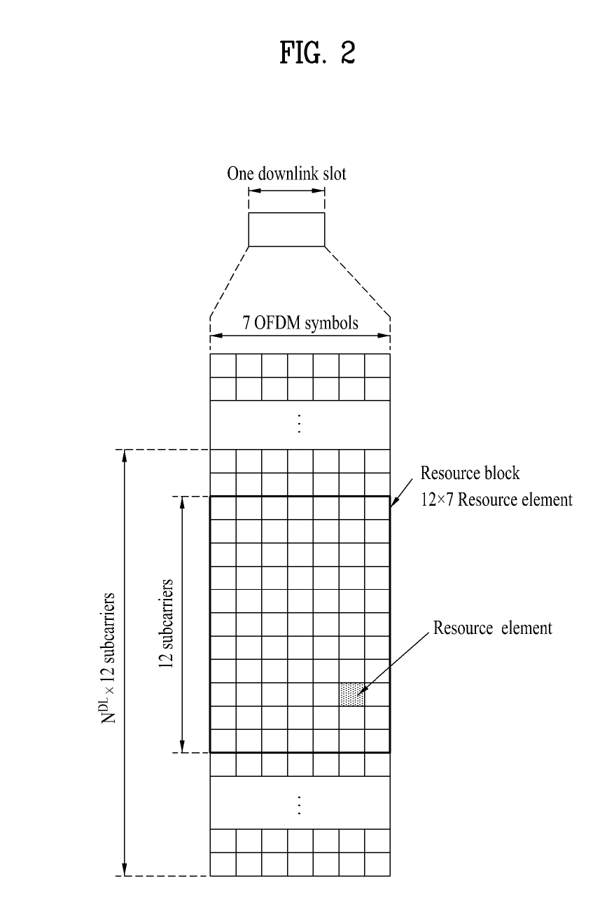

FIG. 3 illustrates a structure of a CRS according to the number of transmit antennas in a 3GPP LTE Rel-8 system.

FIG. 4 illustrates a DM-RS of an Rel-9 system.

FIG. 5 illustrates a DM-RS in an Rel-10 system.

FIG. 6 illustrates a structure of a base station according to an embodiment of the present invention.

FIG. 7 illustrates a data transmission method according to an embodiment of the present invention.

FIG. 8 illustrates a method for transmitting semi-persistent scheduling (SPS) data according to an embodiment of the present invention.

FIG. 9 illustrates a configuration of a mobile station and a base station according to another embodiment of the present invention, through which the embodiments of the present invention described above can be implemented.

### BEST MODE

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details. For example, although the following descriptions will be given in detail with reference to the case in which the mobile communication system is a 3rd Generation Partnership Project (3GPP) LTE-A system, the following descriptions, except descriptions specific to 3GPP LTE-A, may be applied to any other mobile communication system.

In some instances, known structures and devices are omitted or shown in block diagram form, focusing on important features of the structures and devices, so as not to obscure the concept of the present invention. The same reference numbers will be used throughout this specification to refer to the same or like parts.

In the following description, the term “terminal” is used to generally describe any mobile or stationary user device such as a User Equipment (UE), a Mobile Station (MS), or a relay node. In addition, the term “base station” is used to generally describe any network node that communicates with the terminal such as a Node B, an eNode B, or a relay node.

First, reference signals of a 3GPP Rel-9 and Rel-10 systems are described below with reference to the drawings.

The Rel-10 system uses a dedicated demodulation reference signal (DM-RS) for channel estimation and demodulation of downlink transmission data and a channel state information RS (CSI-RS) for estimation of channel status information (CSI) of an overall system bandwidth.

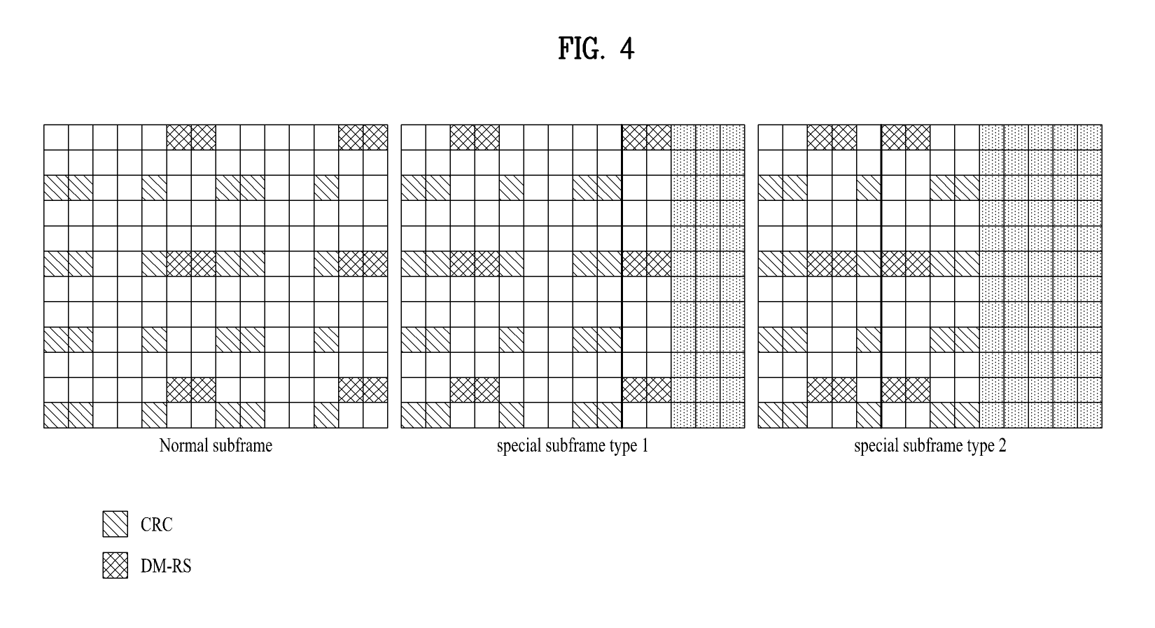

FIG. 4 illustrates a DM-RS of an Rel-9 system.

Orthogonal RS resources for up to 2 transmission layers in association with a downlink dual-layer beamforming transmission mode which has been newly defined in the Rel-9 system are defined as 2 orthogonal code resources which are defined through an orthogonal code cover (OCC) of length 2 mapped onto DM-RS Resource Elements (REs) of two contiguous OFDM symbols. The DM-RS REs of the Rel-9 system are arranged in an RB in a form as shown in FIG. 4.

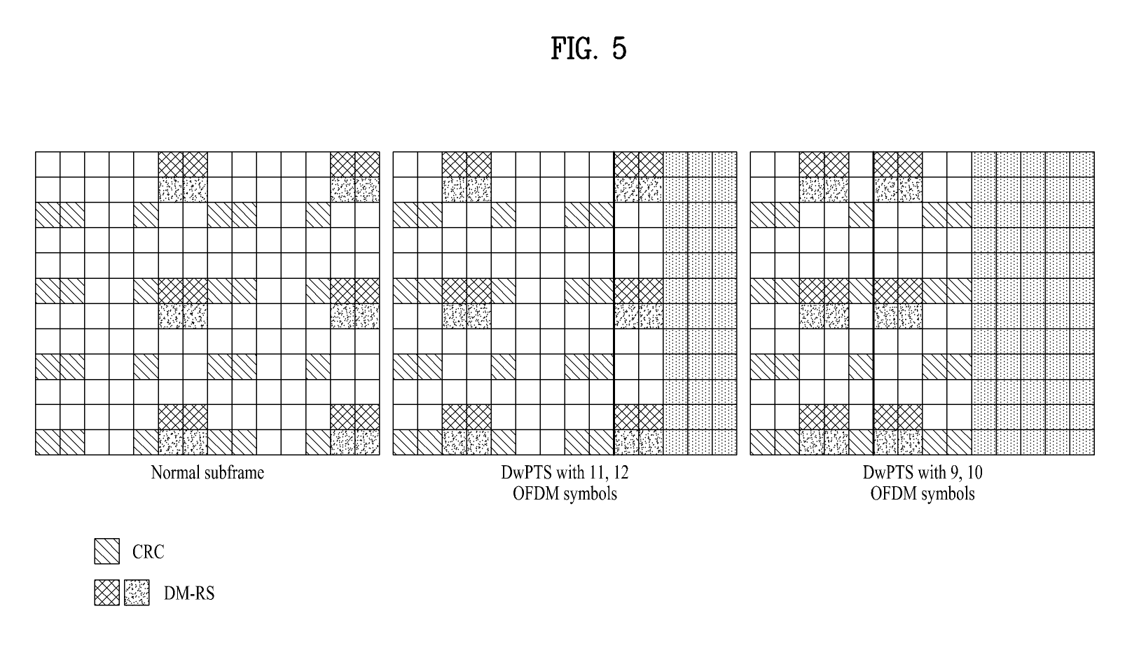

FIG. 5 illustrates a DM-RS in the LTE-A system.

In the LTE-A system, there is a need to provide up to orthogonal DM-RS resources (or resource units) when the number of transmission antennas is 8.

As shown in FIG. 5, two CDM group patterns are defined as subcarrier resources that are discriminated from each other in a physical resource block (PRB) and the same single CDM pattern as the DM-RS of the LTE Rel-9 system is defined for up to rank 2 and an OCC of length 2 is mapped to DM-RS REs, which can be understood as having the same meaning as subcarriers, on contiguous OFDM symbols to define up to 2 orthogonal RS code resources. In the case of ranks 3 and 4, 2 CDM group patterns which are defined as subcarrier resources that are discriminated from each other are applied and, for each of the 2 CDM group patterns, an OCC of length 2 is mapped to DM-RS REs on contiguous OFDM symbols to define up to 2 orthogonal RS code resources. In case of ranks 5 to 8, for each of the 2 CDM group patterns, an OCC of length 4 is mapped to 4 DM-RS REs having the same frequency subcarrier index on 4 OFDM symbols including DM-RSs in a subframe to define up to 4 orthogonal RS code resources.

Unlike a CRS of the Rel-8 system, the downlink DM-RS does not serve to measure channel status information such as a CQI, a PMI, and an RI but instead serves to demodulate a Physical Downlink Shared Channel (PDSCH) on scheduled frequency resources. Accordingly, the DM-RS is defined as a PRB unit on frequency resources allocated to a mobile station. In addition, a number of defined orthogonal DM-RS resources (or resource units) corresponding to the number of transmission layers are precoded using a precoding matrix or a precoding vector that is used to precode data transmitted through frequency resources allocated to the mobile station. Therefore, there is no need to notify the mobile station of which PMI has been applied to transmit data of frequency resources set for the mobile station through a Physical Downlink Control Channel (PDCCH).

Further, the downlink DM-RS defined in the LTE-A (LTE Rel-10) is characterized in that a number of RS resources corresponding to the number of transmission layers calculated based on the rank value are used basically assuming that the RS resources are precoded as an RS applied only to a new transmission mode defined in the LTE-A.

In the LTE-A system, a CSI-RS is defined to measure channel status information with low overhead. While the CRS of the Rel-8 system is transmitted every subframe, the CSI-RS is transmitted at intervals of a specific number of subframes and does not need to be used for demodulation. Therefore, the CSI-RS has a smaller RS density in an overall transmission period than the CRS of the Rel-8 system. The CSI-RS has been determined such that 1 RE is defined per antenna port in each PRB in an arbitrary downlink subframe in which the CSI-RS is transmitted. For example, in a base station of an LTE-A system having 8 transmit antennas, 1 RE is set per individual transmit antenna in each PRB in a CSI-RS transmission subframe such that a total of 8 REs is set per PRB. A CSI-RS that is transmitted from a base station of an LTE-A system is received by LTE-A mobile stations in the coverage of the base station and is used for channel status information measurement. In the case in which conventional LTE Rel-8 and Rel-9 mobile stations have been allocated a specific PRB in a CSI-RS transmission subframe as a transmission frequency band, the mobile stations regard CSI-RS REs as data and perform channel estimation using a conventional CRS to perform demodulation and channel decoding since the mobile stations are not aware of presence of the CSI-RS. The following is a description of RSs for downlink subframes of an LTE-A system. In the LTE-A system, it is possible to define and use a normal subframe that can be used to allocate downlink transmission frequency resources to an LTE mobile station and an LTE-A mobile station and an LTE-A subframe that can be used to allocate downlink transmission frequency resources only to an LTE-A mobile station.

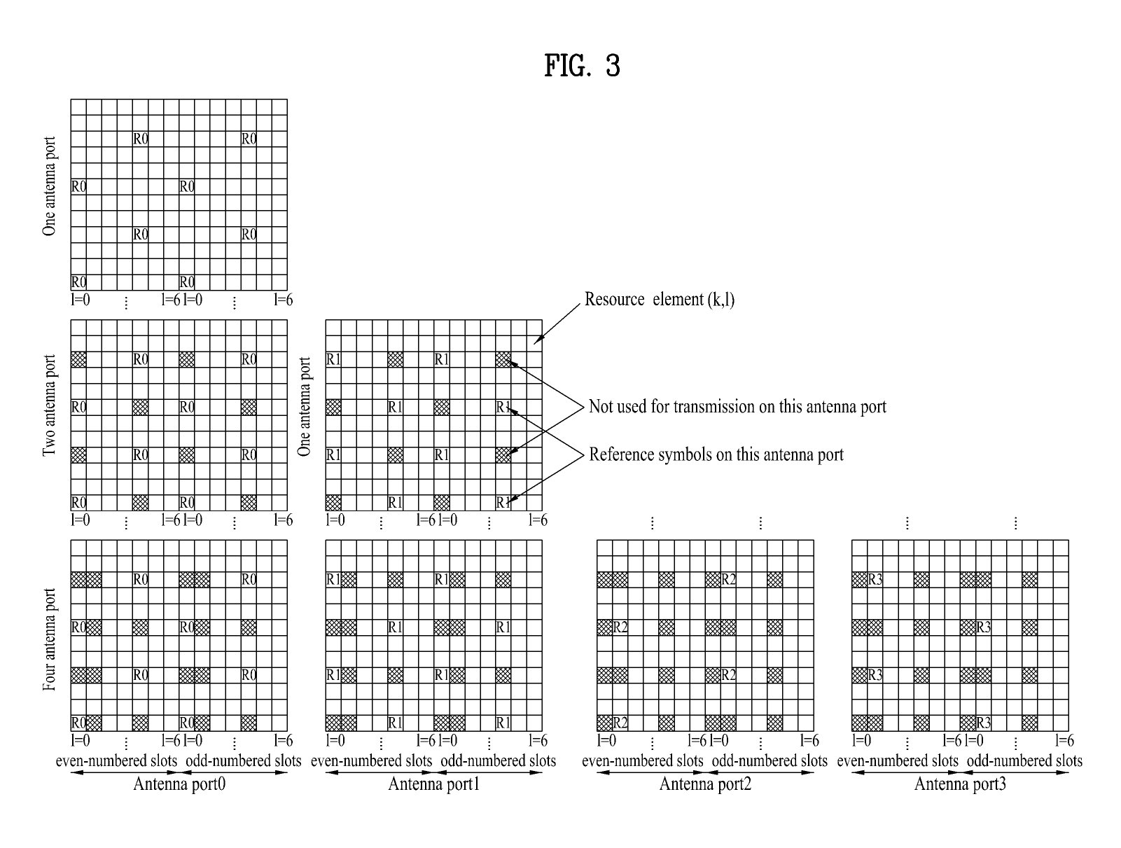

The normal subframe includes all CRS patterns defined in the legacy LTE Rel-8 and Rel-9 and an LTE-A DM-RS pattern and an LTE-A CSI-RS pattern. The same number of CRS patterns as the number of antenna ports according to the conventional transmission mode configured in the LTE-A base station are defined on all downlink subframes as shown in FIG. 3. In the case in which an LTE-A transmission mode is configured in a PRB in which resources have been allocated to an LTE-A mobile station, a downlink DM-RS is defined according to the number of transmission layers as shown in FIG. 5 and a CSI-RS is defined in a specific downlink subframe according to the CSI-RS transmission period.

An LTE-A subframe includes an LTE Rel-8 or Rel-9 CRS only in a PDCCH region (the 1st OFDM symbol or the 1st and 2nd OFDM symbols in a downlink subframe) and includes an LTE-A DM-RS and an LTE-A CSI-RS in the remaining PDSCH transmission OFDM symbol region.

In the PDCCH region of the LTE-A subframe, a CRS pattern of the Rel-8 system is defined according to the number of conventional antenna ports for PDCCH demodulation and a CRS pattern is not defined in the PDSCH region. In addition, in the case in which an LTE-A transmission mode is configured in a PRB in which resource allocation has been performed upon an LTE-A mobile station, a downlink LTE-A DM-RS is defined as shown in FIG. 5 according to the number of transmission layers in the format as described above and an LTE-A CSI-RS is defined in a specific downlink subframe according to the LTE-A CSI-RS transmission period. Basically, it is possible to employ a configuration in which a conventional LTE Rel-8 downlink transmission mode is not set based on a scheme in which an RS is applied to an LTE-A mobile station in an LTE-A subframe.

More specifically, an LTE-A DM-RS for demodulation of downlink transmission defined in LTE-A is basically precoded assuming that all downlink LTE-A transmission modes are configured based on precoding. This LTE-A DM-RS may be inappropriate for use as an RS for channel estimation and demodulation in the case in which a base station has set a transmit diversity transmission mode for an LTE-A mobile station and has scheduled downlink transmission using the transmission mode in an LTE-A subframe. As a solution to this situation, it is possible to demodulate data of a PDSCH region using a CRS of a PDCCH region. However, this may significantly reduce channel estimation performance when taking into consideration that the LTE Rel-8 transmit diversity transmission mode is generally applied in a situation in which the Doppler frequency is high.

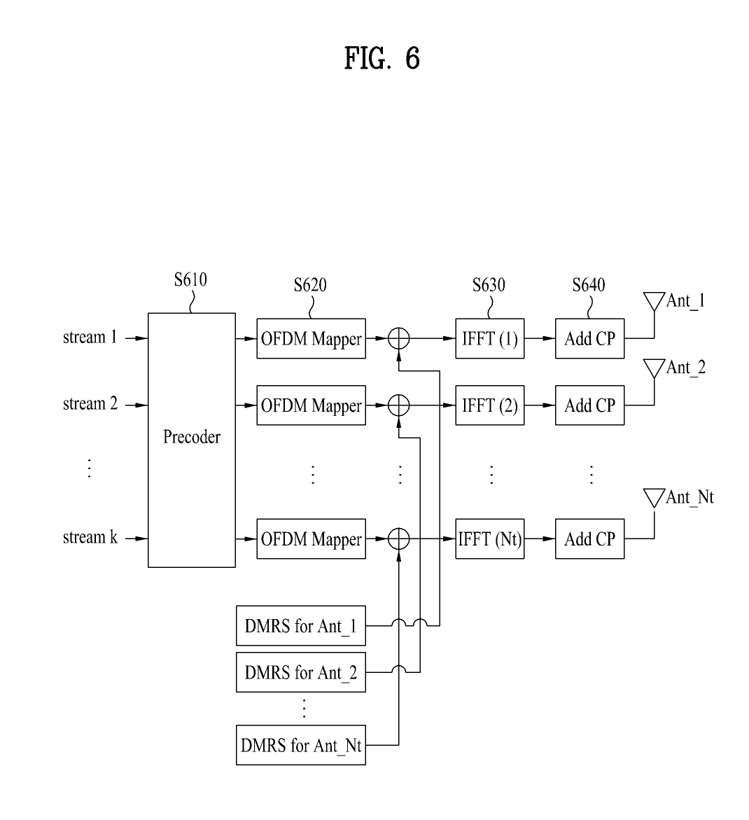

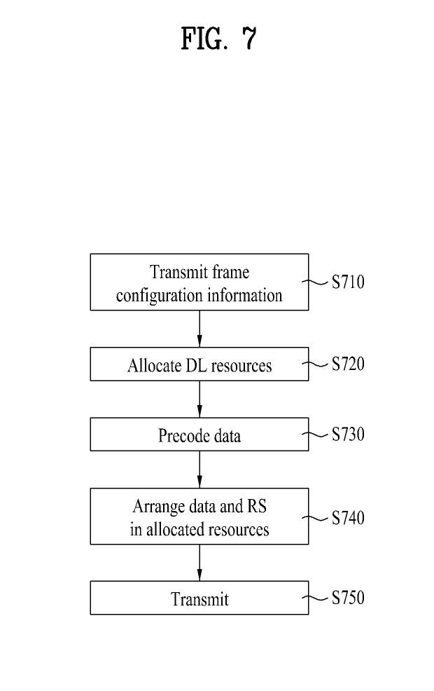

A method and apparatus for transmitting and receiving data using a transmit diversity scheme in a wireless communication system according to an embodiment of the present invention will now be described with reference to FIGS. 6 and 7.

According to an embodiment of a method for applying an RS for appropriate channel estimation when transmitting data to an LTE-A mobile station in a transmit diversity transmission mode in an LTE-A subframe suggested in the present invention, a base station defines and maps an LTE-A DM-RS on a PRB by PRB basis on frequency resources set when transmitting data to an LTE-A mobile station in an LTE-A subframe using a transmit diversity scheme and transmits the LTE-A DM-RS without precoding the LTE-A DM-RS. This allows the LTE-A mobile station to demodulate a corresponding data signal by receiving the LTE-A DM-RS which has not been precoded and performing channel estimation using the received LTE-A DM-RS. Here, LTE-A DM-RS patterns of FIG. 3 or FIG. 5 are defined and applied according to the number of orthogonal resources of the LTE-A DM-RS required according to the number of transmit antenna ports applied to the transmit diversity transmission mode. As orthogonal resource indices of the LTE-A DM-RS defined in such a transmission situation, it is possible to define the same number of DM-RS resource indices as required in the transmission situation, sequentially selected from a predefined range of DM-RS resource indices from a start point (for example, index 0) thereof, and also to define the same number of DM-RS resource indices as required in the transmission situation, sequentially and cyclically selected from the predefined range of DM-RS resource indices from the start point at intervals of an index offset.

FIG. 6 illustrates a structure of a base station according to an embodiment of the present invention. As shown in FIG. 6, the base station according to the embodiment of the present invention includes a precoder 610, an OFDM mapper 620, an inverse fast Fourier transformer (IFFT) 630, and a cyclic prefix (CP) adder 640.

When a data stream (or data) to be transmitted is input, the precoder 610 precodes data to be transmitted by multiplying the data by a precoding matrix having a format which implements the transmit diversity transmission mode described above in the present invention. The precoding process may be understood as a process for transmission in the transmit diversity transmission mode, unlike precoding corresponding to the precoding transmission mode that has been described above as a transmission mode in the present invention.

The OFDM mapper 620 maps the precoded data to an OFDM symbol of an RB allocated to the mobile station. Then, the base station arranges respective LTE-A DM-RSs of antennas in the frequency resources by mapping the LTE-A DM-RS of each antenna to an RB allocated to the mobile station.

The IFFT 630 then IFFTs the data and, the RS and the CP adder 640 adds a CP to the resulting data and RS. The base station then transmits the data and RS using the transmit diversity scheme.

FIG. 7 illustrates a data transmission method according to an embodiment of the present invention.

As shown in FIG. 7, a base station transmits frame configuration information to a mobile station (S710). As a frame includes a normal subframe and an LTE-A subframe, the base station provides information indicating the ordinal of the normal subframe and the ordinal of the LTE-A subframe to the mobile station through cell-specific or MS-specific Radio Resource Control (RRC) signaling.

The base station allocates downlink resources of an LTE-A subframe to the mobile station (S720).

The base station precodes data to be transmitted to the mobile station (S730). The base station precodes the data to be transmitted by multiplying the data by a precoding matrix determined according to a precoding matrix index fed back from the mobile station or a precoding matrix arbitrarily determined by the base station. In the case in which the transmit diversity transmission mode has been set, the data precoding has a different meaning from precoding of the precoding transmission mode and may be understood as a type of precoding used in a method for implementing the transmit diversity scheme described above in the present invention.

The base station arranges the precoded data and the DM-RS of each antenna applied to transmit diversity in the allocated resources (S740) and transmits the resulting data and DM-RS (S750).

Since the LTE-A DM-RS applied in the suggestions of the present invention is used without applying precoding to transmit diversity and is individually transmitted for each antenna port, there is a need to define the same number of (Nt) LTE-A DM-RS patterns as the number of antenna ports applied to transmit diversity. When LTE-A DM-RS patterns applied to the suggestions of the present invention have resource indices as described above, LTE-A DM-RS resources may use a series of Nt DRS patterns that are selected from a range of DM-RS resource indices from a start point thereof and may also use Nt LTE-A DM-RS resources that are selected from the range of DM-RS resource indices from the start point on a predetermined offset basis. For example, in the case in which 8 LTE-A DM-RS orthogonal resources are defined, corresponding LTE-A DM-RS resource indices 0 to 7 are defined, and Nt is 4, the base station may set the start point to 0 and apply LTE-A DM-RS orthogonal resources whose DM-RS resource indices are 0, 1, 2, and 3 and may also set the start point to 0 and the offset to 2 and apply LTE-A DM-RS orthogonal resources whose DM-RS resource indices are 0, 2, 4, and 6.

If the base station transmits the LTE-A DM-RS in an LTE-A subframe without precoding the LTE-A DM-RS as described above in this embodiment, the LTE-A mobile station may receive the data which has been transmitted using the transmit diversity scheme and the LTE-A DM-RS which has not been precoded and then may perform channel estimation and demodulate the received data using the received RS.

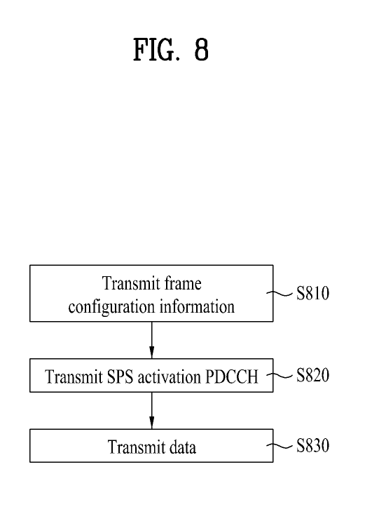

Next, a method for an LTE-A base station to configure and transmit semi-persistent scheduling (SPS) data using a transmit diversity scheme according to an embodiment of the present invention is described below with reference to FIG. 8. FIG. 8 illustrates a method for transmitting SPS data according to an embodiment of the present invention.

As shown in FIG. 8, the LTE-A base station transmits frame configuration information to an LTE or LTE-A mobile station (S810) and then transmits an SPS activation PDCCH (S820). The SPS activation PDCCH may include a subframe index offset indicating the transmission period of SPS data and the transmission time of SPS data and may transmit corresponding configuration information through RRC signaling specific to the mobile station. Here, the LTE-A base station may determine the subframe index offset and the transmission period of SPS data such that SPS data is not transmitted in an LTE-A subframe taking into consideration the fact that the transmit diversity transmission mode is mainly used for reliable transmission of the SPS data in a situation in which it is difficult to perform optimal channel-dependent scheduling.

Here, the LTE-A base station transmits SPS data to the mobile station through a normal subframe using the transmit diversity scheme according to information that has been transmitted through an SPS activation PDCCH and the normal subframe includes a CRS, the mobile station can demodulate downlink SPS data, which has been transmitted using the transmission diversity mode, using the CRS.

To avoid problems associated with reception and demodulation by a mobile station in the case in which an LTE-A base station transmits SPS data to the mobile station in an LTE-A subframe using a transmit diversity scheme as described above in the present invention, it is possible to apply a method in which the LTE-A base station configures an LTE-A subframe by setting the LTE-A subframe such that the LTE-A subframe does not overlap with a downlink SPS transmission subframe.

For example, it is possible to apply a method in which, taking into consideration that Voice over IP (VoIP) data, which is main data traffic of SPS transmission, is transmitted at intervals of a transmission period of 20 ms, the LTE-A base station limits a subframe offset as a start point of VoIP transmission from the base station to a specific value when configuring an LTE-A subframe in a radio frame or an integer number of radio frames and sets and configures the LTE-A subframe such that the LTE-A subframe does not overlap with a downlink SPS transmission subframe.

Alternatively, in the case in which the base station has determined the transmission period of SPS data and the subframe index offset without taking into consideration the position of an LTE-A subframe such that the transmission time of SPS data is the LTE-A subframe, the base station may not transmit SPS data in the LTE-A subframe and instead may transmit SPS data when the transmission time of the SPS data is a normal subframe. That is, the base station transmits SPS data at the first SPS data transmission time which does not overlap with the LTE-A subframe.

In another example, in the case in which the transmission time of SPS data is an LTE-A subframe, the base station may not transmit the SPS data in the LTE-A subframe and instead may transmit the SPS data at the time of retransmission of corresponding data.

Here, it is possible to apply a method in which, when the LTE-A base station has transmitted downlink SPS according to the transmit diversity transmission mode, the mobile station may compare SPS activation PDCCH information and frame configuration information received from the base station and may determine that the mobile station is to receive the SPS data at the first subframe which does not overlap with the LTE-A subframe or at the time of retransmission in the case in which transmission time of the SPS data and the LTE-A subframe overlap and then may receive the SPS data in the corresponding subframe.

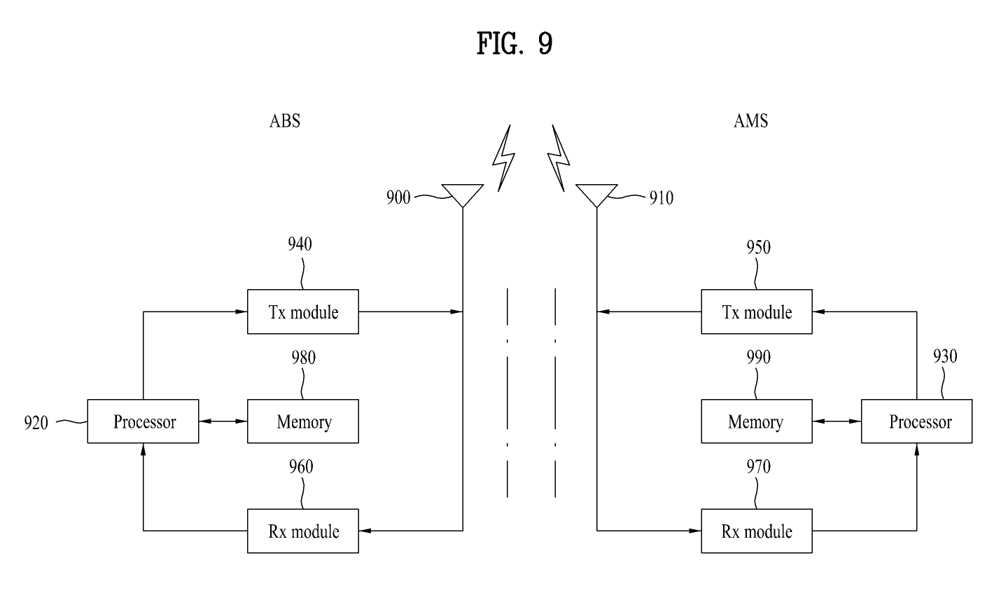

FIG. 9 illustrates a configuration of a mobile station and a base station according to another embodiment of the present invention, through which the embodiments of the present invention described above can be implemented.

An Advanced Mobile Station (AMS) and an Advanced Base Station (ABS) may include antennas 900 and 910 for transmitting and receiving information, data, signals, messages, and/or the like, transmission modules (Tx modules) 940 and 950 for transmitting messages through antenna control, reception modules (Rx modules) 960 and 970 for receiving messages through antenna control, memories 980 and 990 for storing information items associated with communication between the AMS, and the ABS, and processors 920 and 930 for controlling the transmission modules, the reception modules, and the memories, respectively. Here, the ABS may be a femto ABS or a macro ABS.

The antennas 900 and 910 function to transmit signals generated by the transmission modules 940 and 950 to the outside or to receive radio signals from the outside and deliver the received radio signals to the reception modules 960 and 970. In the case in which a multi-antenna (MIMO) function is supported, 6 or more antennas may be provided.

The processors 920 and 930 generally control overall operations of the AMS and the ABS, respectively. Specifically, each of the processors 920 and 930 may perform a control function for implementing the embodiments of the present invention described above, a function to perform MAC frame variable control according to service characteristics and radio environments, a handover function, authentication and encryption functions, and the like. Each of the processors 920 and 930 may also include an encryption module that can control encryption of a variety of messages and a timer module that controls transmission and reception of a variety of messages.

The transmission modules 940 and 950 may perform coding and modulation of signals and/or data, which have been scheduled by the processors to be transmitted to the outside, and then may deliver the resulting signals and/or data to the antennas 900 and 910, respectively.

The reception modules 960 and 970 may perform decoding and demodulation upon radio signals received from the outside through the antennas 900 and 910 to restore the radio signals into original data and then may deliver the original data to the processors 920 and 930, respectively.

The memories 980 and 990 may store programs for processing and control by the processors and may also temporarily store input/output data items. In the case of the AMS, the temporarily stored input/output data items include a UL grant, system information, a station identifier (STID), a flow identifier (FID), an action time, region allocation information, and frame offset information, and the like.

The memories may include a storage medium of at least one of a flash memory type, a hard disk type, a multimedia card micro type, a card type (for example, SD or XD memory), Random Access Memory (RAM) Static Random Access Memory (SRAM), Read-Only Memory (ROM), Electrically Erasable Programmable Read-Only Memory (EEPROM), Programmable Read-Only Memory (PROM), a magnetic memory, a magnetic disc, and an optical disc.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may combine the structures described in the above embodiments in a variety of ways.

Accordingly, the invention should not be limited to the specific embodiments described herein, but should be accorded the broadest scope consistent with the principles and novel features disclosed herein.

1. A method for transmitting data using a transmit diversity scheme in a base station in a wireless communication system, the method comprising:
allocating a downlink resource to a mobile station;
precoding data to be transmitted to the mobile station; and
arranging the precoded data and a non-precoded demodulation reference signal (DMRS) in the allocated resource and transmitting the precoded data and the non-precoded DMRS.

2. The method according to claim 1, wherein the DMRS is transmitted for each antenna port used in the transmit diversity scheme.

3. The method according to claim 2, wherein the DMRS includes the same number of dedicated reference signal patterns as the number of the antenna ports.

4. The method according to claim 3, wherein indices of the dedicated reference signal patterns are consecutive.

5. A method for receiving data using a transmit diversity scheme in a mobile station in a wireless communication system, the method comprising:
receiving a downlink resource that has been allocated to the mobile station by a base station;
receiving precoded data and a non-precoded demodulation reference signal (DMRS) from the base station through the allocated resource; and
demodulating the data using the DMRS.

6. The method according to claim 5, wherein the DMRS is transmitted for each antenna port used in the transmit diversity scheme.

7. A base station comprising:
a processor for precoding data to be transmitted to a mobile station and arranging the precoded data and a non-precoded demodulation reference signal (DMRS) in a resource region allocated to the mobile station; and
transmitting the precoded data and the non-precoded DMRS using a transmit diversity scheme.

8. A mobile station comprising:
a reception module for receiving precoded data and a non-precoded demodulation reference signal (DMRS) through a resource region that has been allocated to the mobile station by a base station; and
a processor for demodulating the data using the DMRS.

9. A method for transmitting semi-persistent scheduling (SPS) data using a transmit diversity scheme in a base station in a wireless communication system that supports an LTE mobile station and an LTE-A mobile station, the method comprising:
transmitting frame configuration information indicating a position of an LTE-A subframe to a mobile station;
transmitting an SPS activation Physical Downlink Control Channel (PDCCH) including information associated with a transmission time of the SPS data to the mobile station; and
transmitting the SPS data to the mobile station at a next SPS data transmission time when the transmission time of the SPS data overlaps with the LTE-A subframe,
wherein the LTE-A subframe is allowed to be allocated only to the LTE-A mobile station.

10. A method for receiving semi-persistent scheduling (SPS) data using a transmit diversity scheme in a mobile station in a wireless communication system that supports an LTE mobile station and an LTE-A mobile station, the method comprising:
receiving frame configuration information indicating a position of an LTE-A subframe from a base station;
receiving an SPS activation Physical DL Control Channel (PDCCH) including information associated with a transmission time of the SPS data from the base station; and
receiving the SPS data from the base station at a next SPS data transmission time when the transmission time of the SPS data overlaps with the LTE-A subframe,
wherein the LTE-A subframe is allowed to be allocated only to the LTE-A mobile station.
